(19) United States
(12) Patent Application Publication
(10) Pub. No.: US 2014/0033077 A1
(43) Pub. Date: Jan. 30, 2014

(54) Spreading User Activities to Interested Users of a Community

(71) Applicants: Lalitesh Kumar Katragadda, Hyderabad (IN); Sreejit Unnikrishnan, Bangalore (IN); Amardeep Singh, Bangalore (IN); Kaushik Sridharan, Bangalore (IN); Vinay Chitlangia, Bangalore (IN); Arijit De, Bangalore (IN)

(72) Inventors: Lalitesh Kumar Katragadda, Hyderabad (IN); Sreejit Unnikrishnan, Bangalore (IN); Amardeep Singh, Bangalore (IN); Kaushik Sridharan, Bangalore (IN); Vinay Chitlangia, Bangalore (IN); Arijit De, Bangalore (IN)

(73) Assignee: GOOGLE INC., Mountain View, CA (US)

(21) Appl. No.: 14/110,900

(22) PCT Filed: Apr. 10, 2012
(86) PCT No.: PCT/US2012/032907

§ 371 Date: Oct. 9, 2013

(30) Foreign Application Priority Data
Apr. 12, 2011 (IN) 1289/CHE/2011

(51) Int. Cl. H04L 29/06

(52) U.S. Cl. CPC H04L 65/403
USPC 715/753

(57) ABSTRACT

Map curators perform activities related to digital maps provided. These activities include adding and/or modifying information about map features displayed on the digital maps. Edits to these map features are included in a pulse stream which is formatted so as to be visually appealing to other curators who view the edits in the pulse stream. The pulse stream is distributed to other curators or to users have yet to provide edits to the digital maps. The pulse stream of edits informs these users of the activities that have transpired with respect to the digital maps in hopes to inspire them to further contribute additional edits to the digital maps.

### TECHNICAL FIELD

The embodiments disclosed herein generally relate displaying user activities that are associated with a community product to inform others of these activities. More particularly, the embodiments herein relate to informing individuals of edits that have been made to a digital map.

### BACKGROUND

For products that include user generated content (i.e., community products), the involvement and collaboration of users to add and/or revise user generated content supports the growth and spread of the community products. For example, in a map based product, curators of digital maps promote growth of the product by providing and/or editing information concerning map features such as points of interests, roads, buildings, restaurants, etc. These curators are typically users who care about the growth and accuracy of the information included in the product and may be content contributors for the product rather than individuals such as system administrators, who have a vested interest in the product. However, it is currently difficult to motive and inspire users to contribute user generated content that promotes the development and growth of the product.

### SUMMARY

Embodiments disclosed herein generally enable mechanisms that inform and incent users of a community to perform various activities associated with a community product such as a digital map product. Digital maps include map features that describe real world physical objects that may be represented on the digital maps. These features include points of interest such as buildings, stores, restaurants, water bodies, etc.

Users are generally classified either as non-contributing users or as curators. In one embodiment, a curator of digital maps is an individual who contributes new features or contributes/modifies information about existing features of the digital maps. Their contribution allows the digital maps to improve in terms of the feature information available through the maps. In contrast, a non-contributing user is an individual who merely consumes (i.e., views) digital maps for some purpose such as for directions or for pleasure. That is, a non-contributing user is an individual who has yet to provide any contributions to the digital maps.

To encourage users to contribute information to the digital maps, a pulse stream of edits is provided to the users. In one embodiment, a pulse stream is a collection of previous edits that have been selected according to a set of filtering parameters. The pulse stream is then formatted to be presented in a visually appealing manner. Each formatted edit in a pulse stream conveys a curator's contribution to the digital maps. Thus, the pulse stream describes the collective edits made to the digital map from curators across the globe or some region thereof. Viewing the pulse stream inspires users (i.e., curators and non-contributing users) to contribute to the improvement of information in the digital maps.

In one embodiment, to provide the pulse stream, edits made by curators of the digital map are automatically retrieved. Each edit is formatted by a geographic information server so as to be visually appealing to the consumers who view the edits, and included in a pulse stream. The pulse stream is provided to one or more users to inform the users of the activities that have taken place with respect to the digital maps.

The features and advantages described in this summary and the following detailed description are not all inclusive. Many additional features and advantages will be apparent to one of ordinary skill in the art in view of the drawings, specification and claims.

### BRIEF DESCRIPTION OF THE DRAWINGS

FIG. 1 illustrates a system architecture of a geographic information server in accordance with one embodiment.

FIGS. 2A-2D illustrate user interfaces for submitting edits to a digital map in accordance with one embodiment.

FIGS. 3A-3C illustrates portions of a pulse stream that conveys to other users edits made to digital maps, according to one embodiment.

FIG. 4 illustrates a portion of a pulse stream that conveys to other users edits made to digital maps, according to one embodiment.

FIG. 5 illustrates a method for providing a pulse stream to users of the digital maps, according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Overview

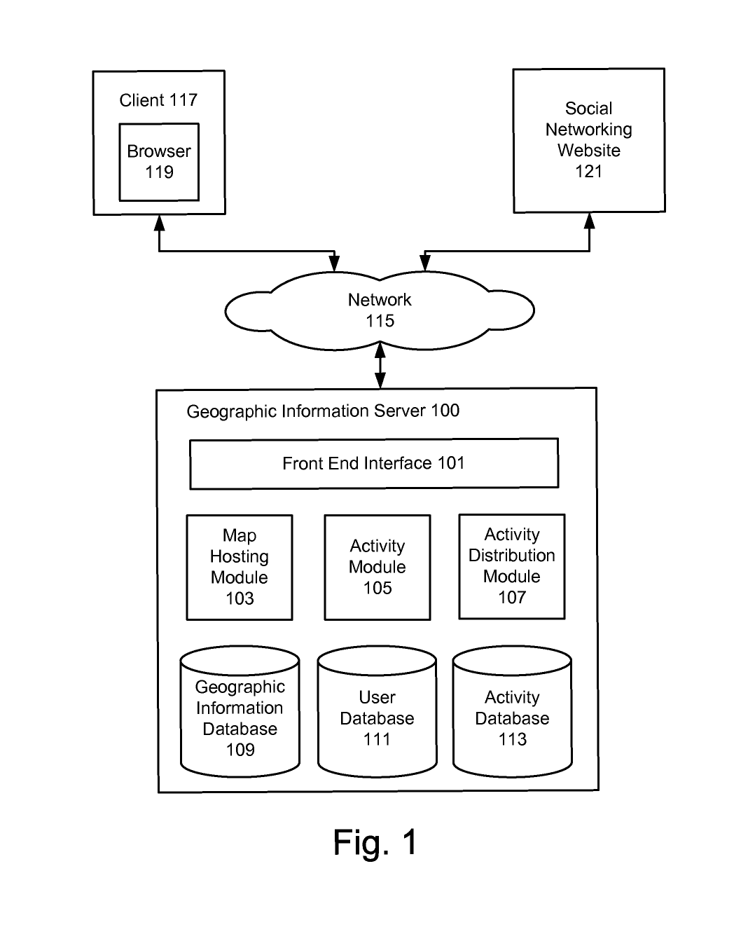

FIG. 1 illustrates a system architecture of a geographic information server 100 in accordance with one embodiment. Generally, the geographic information server 100 provides digital maps to users. The digital maps allow users to see and discover various places located around the globe from their current location.

The geographic information server 100 allows map curators to perform activities related to the digital maps. In one embodiment, a “map curator” is an individual who provides user generated content with respect to the digital maps. A “non-contributing user” in contrast is an individual that has not provided user generated content with respect to the digital maps, but merely consumes the digital maps for viewing. Both map curators as well as non-contributing users are considered “users” of the geographic information server 100.

The activities performed by curators related to the digital maps may include adding and/or modifying information about map features displayed on the maps (referred to as making “edits”). In one embodiment, a map feature signifies any entity that may be represented on a digital map. For example, map features may include points of interest such as establishments, buildings, parks, water bodies, roads, highways, etc. that are displayed on the map. Thus, the geographic information server 100 motivates users (i.e., contributors and non-contributing users) to discover, share, and add their own knowledge in the form of user generated content to the digital maps. By allowing users to edit the digital maps, the information available from the digital maps themselves grows due to the addition of edits with respect to new and/or existing features of the map. In a specific example, consider a restaurant that is represented on a digital map provided by the geographic information server 100. A curator may provide edits associated with the restaurant in the form of information describing the hours of operation of the restaurant, forms of accepted payment, and/or type of cuisine served at the restaurant.

In order to encourage curators to continually contribute edits to the digital maps and to encourage non-contributing users to begin contributing edits, the geographic information server 100 provides a pulse stream that indicates the various activities that have been performed by other curators with respect to the digital maps. That is, a pulse stream describes the collective edits that have been made to the digital maps by curators. The pulse stream comprises a plurality of edits and is formatted so as to be presented in a visually appealing manner. For the restaurant example described above, the geographic information server 100 may include the pulse stream in an aesthetically appealing user interface that indicates the information that has been added, deleted, and/or edited by the curator with respect to the restaurant as well as an indication of the identity of the curator who performed the activity. By providing the pulse stream to other curators or to other users who have yet to contribute any edits (i.e., non-contributing users), these people may become inspired or motivated to provide their contribution to the digital maps.

As shown in FIG. 1, the geographic information server 100 includes a front end interface 101, a map hosting module 103, an activity module 105, an activity distribution module 107, a geographic information database 109, a user database 111, and an activity database 113. Each of these modules is described in further detail below. Many conventional features, such as firewalls, load balancers, application servers, failover servers, site management tools and so forth are not shown so as not to obscure the features of the system.

In one embodiment, a suitable website for implementation of the video hosting server 100 is the GOOGLE™ Map Maker website, found at www.google.com/mapmaker. Other map sites are known as well, and can be adapted to operate according to the teaching disclosed herein. The term “website” represents any computer system adapted to serve content using any networking protocol, and is not intended to be limited to content uploaded or downloaded via the Internet or the HTTP protocol. In general, functions described in one embodiment as being performed on the server side can also be performed on the client side in other embodiments if appropriate. In addition, the functionality attributed to a particular component can be performed by different or multiple components operating together.

In one embodiment, the geographic information server 100 is implemented as server program executing on server-class computer comprising a CPU, memory, network interface, peripheral interfaces, and other well known components. In one embodiment, the computers themselves run an operating system such as LINUX, Microsoft Windows, or Mac OS X, have generally high performance CPUs, 2G or more of memory, and 1TB or more of disk storage. Of course, other types of computers can be used, and it is expected that as more powerful computers are developed in the future, they can be configured in accordance with the teachings here. The functionality implemented by any of the elements can be provided by computer program products (e.g., as computer executable instructions) that are stored in non-transitory computer-readable storage mediums (e.g., RAM, hard disk, or optical/magnetic media).

In one embodiment, and as shown in FIG. 1, a client 117 executing a browser 119 connects to the geographic information server 100 to allow a user to view digital maps provided by the geographic information server 100 via a network 115 such as the Internet or any combination of a LAN, a MAN, a WAN, a mobile, wired or wireless network, a private network, or a virtual private network. While only a single client 117 and browser 119 is shown in FIG. 1, in general very large numbers (e.g., millions) of clients are supported and can be in communication with the geographic information server 100 at any time. In one embodiment, the client 117 can be implemented using any of a variety of different computing devices, some examples of which are personal computers, digital assistants, personal digital assistants, cellular phones, mobile phones, smart phones and laptop computers.

The browser 119 may include any application that allows users of clients 117 to access web pages on the World Wide Web. Suitable applications include, but are not limited to GOOGLE CHROME, MICROSOFT INTERNET EXPLORER, NETSCAPE NAVIGATOR, MOZILLA FIREFOX, and APPLE SAFARI. The browser 119 allows the user of client 117 to access websites comprising digital maps provided by the geographic information server 100 via a user interface provided by the front end interface 101. Through the interface, a user can view digital maps provided by the geographic information server 100 and provide edits to the digital maps as will be further described below.

In one embodiment, the user database 111 stores user profiles stores a record of all users who have registered an account with the geographic information server 100. Each profile includes at least a user name associated with the profile. Each profile may also include a record of all edits submitted by the curator as well as any user settings associated with each individual as is further described below.

The geographic information database 109 stores geographic information used by the geographic information server 100 to generate maps. The geographic information includes map features and their attributes. Generally, a map feature represents a stationary real world object that can be represented on a digital map. In one embodiment, the representation may be a name and a geographic location (e.g., latitude and longitude coordinates) on the digital map. A map feature may also represent conceptual objects such as borders which are not physical real world objects, or historical events that took place at a given location (e.g., a battle, speech, assassination, etc.)

In one embodiment, map features are classified as either point features, geometry features, or line features. A point feature describes a point of interest that may be represented as a single point (e.g., a geospatial identifier such as latitude and longitude coordinates) on the digital map such as an establishment (e.g., restaurant or book store) or a landmark according to one embodiment. Attributes of a point feature comprise at least a geo-code (e.g., latitude and longitude coordinates) describing the location of the point feature, a name or other identifier associated with the point feature (e.g., “Empire State Building”), and a physical address associated with the point feature. Point features may also include other attributes specific to the category of the point feature. For example, a point feature categorized as a “restaurant” may include additional attributes such as hours of operation or accepted forms of payment.

In one embodiment, a geometry feature describes a boundary of a map feature. Generally, a geometry feature represents any feature on a map that may be enclosed by a defined boundary such as a building, park, or water body, etc. Point features may also be associated with a geometry feature. The geometry feature may indicate a boundary of the point feature. For example, the point feature “Empire State Building” may be associated with a geometry feature indicating the area that represents the boundary of the building.

In one embodiment, a boundary of a geometry feature is represented as a series of points that form a closed polygon. Each point of a boundary corresponds to a geospatial identifier such as a latitude and longitude coordinate. The attributes of a geometry feature comprises at least a list of the points that collectively represent the boundary of the geometry feature, a name or other identifier of the geometry feature (e.g., San Francisco Bay), a geographic region associated with the geometry feature, such as city and state, and optionally an associated point feature.

Line features describe linear map features such as roads, highways, intersections, railways, and subways. In one embodiment, a line feature is represented by a plurality of points, each point corresponding to a latitude and longitude coordinate. However, unlike geometry features, the points of a line feature do not form a closed polygon. Though, exceptions to this rule may exist such as the Washington Beltway which is a freeway that forms a closed loop around Washington D.C. The points of a line feature describe the starting location and ending location of the feature as well as any intermediate locations between the starting and ending locations. These intermediate locations may represent any prominent curve or vertex in the line feature between the starting and ending locations. The attributes of a line feature include at least a list of points that represent the line feature, the name or other indicator of the feature (e.g., California Street), and a geographic region in which the feature is located, such as the city and state. Line features may also include other features based on the type of line feature. For example, for a line feature with a category of “road,” the feature may include additional attributes such as the number of lanes on the road, the directions of the travel permitted on the road, and whether parking is permitted on the road.

The map hosting module 103 is any web-based application known in the art that provides digital maps and information about map features, such as business listings, to users. Exemplary web-based applications include GOOGLE Maps and GOOGLE Earth. The map hosting module 103 utilizes the map information in the geographic information database 109 to generate two-dimensional and/or three-dimensional digital maps and populate the maps with map features.

The activity database 113 stores user activities associated with the digital maps provided by the geographic information server 100. In the context of the discussion herein, the activities comprise user-provided edits to digital maps provided by the geographic information server 100. In one embodiment, an edit comprises either an addition of a map feature to a digital map or any modification (including deletion) of an attribute of an existing map feature represented on a digital map or an addition of attributes for existing map features. Note that the activities may also be any activity that is associated with a geocode, time, and author such as a person planning a party at a particular location and time.

In one embodiment, the activity database 113 indexes edits based on various factors such as time and author. Each edit is associated with a time stamp in which the edit was submitted to the geographic information server 100 as well as a user name of the author (curator) who submitted the edit. Additionally, the activity database 113 may index edits based on feature type (e.g., point feature, geometry feature, or line feature) as well as the geographic region associated with the edit. For example, an edit associated with the “Golden Gate Bridge” may be associated with the geographic regions “San Francisco,” “Bay Area,” or “California.”

The activity module 105 receives edits to map features from users of the digital maps. These edits may be received from curators as well as non-contributing users who are contributing for the first time. As described previously, an edit comprises either an addition of a map feature to a digital map or any modification of an attribute of an existing map feature represented on a digital map or an addition of attributes for existing map features.

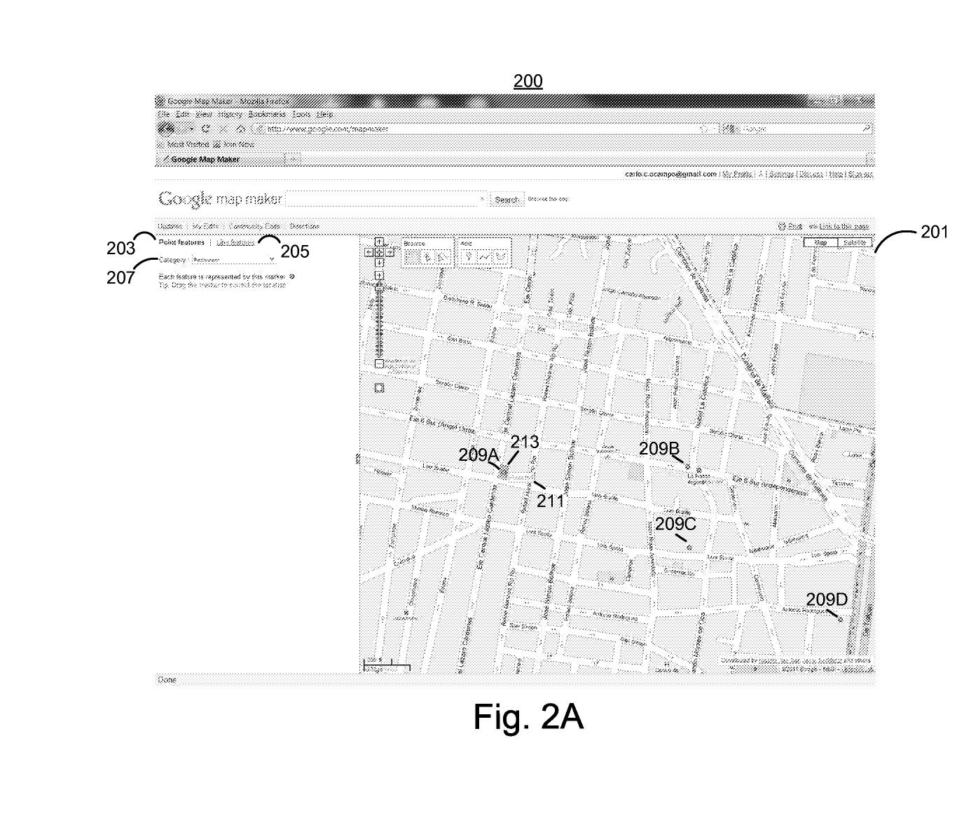

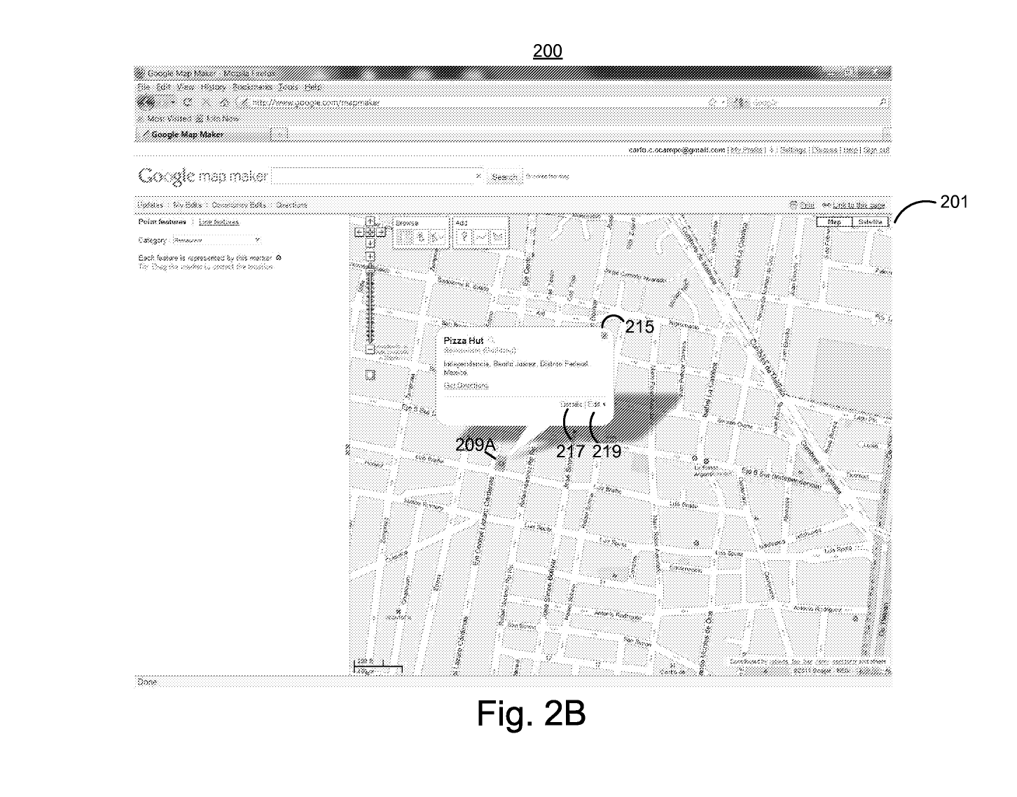

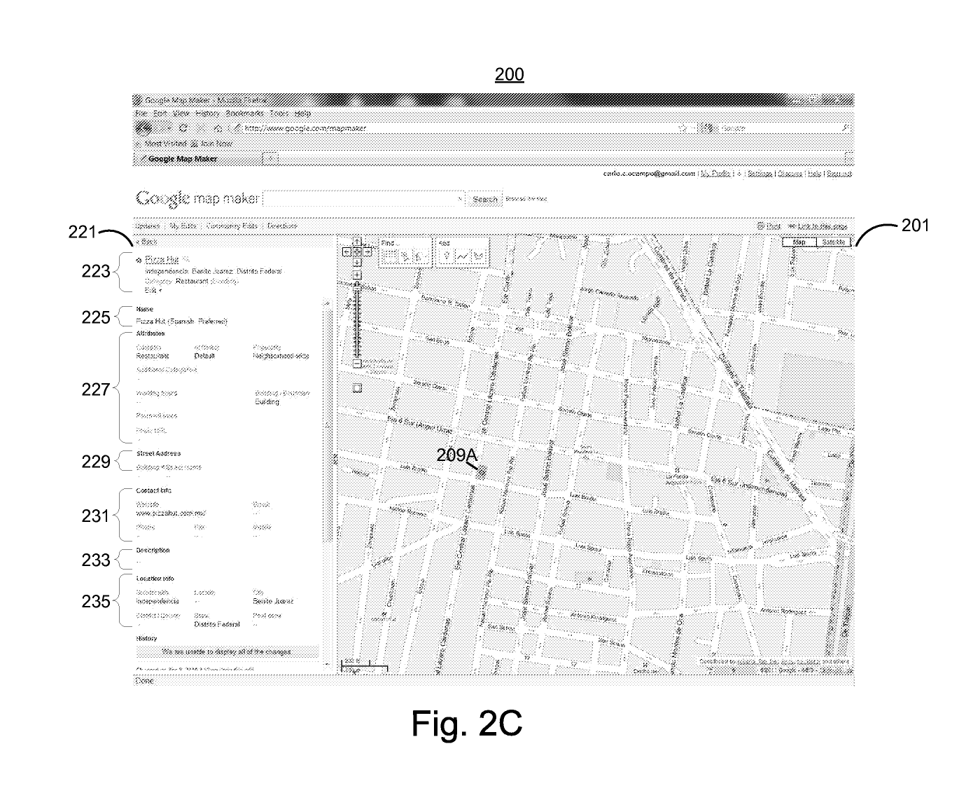

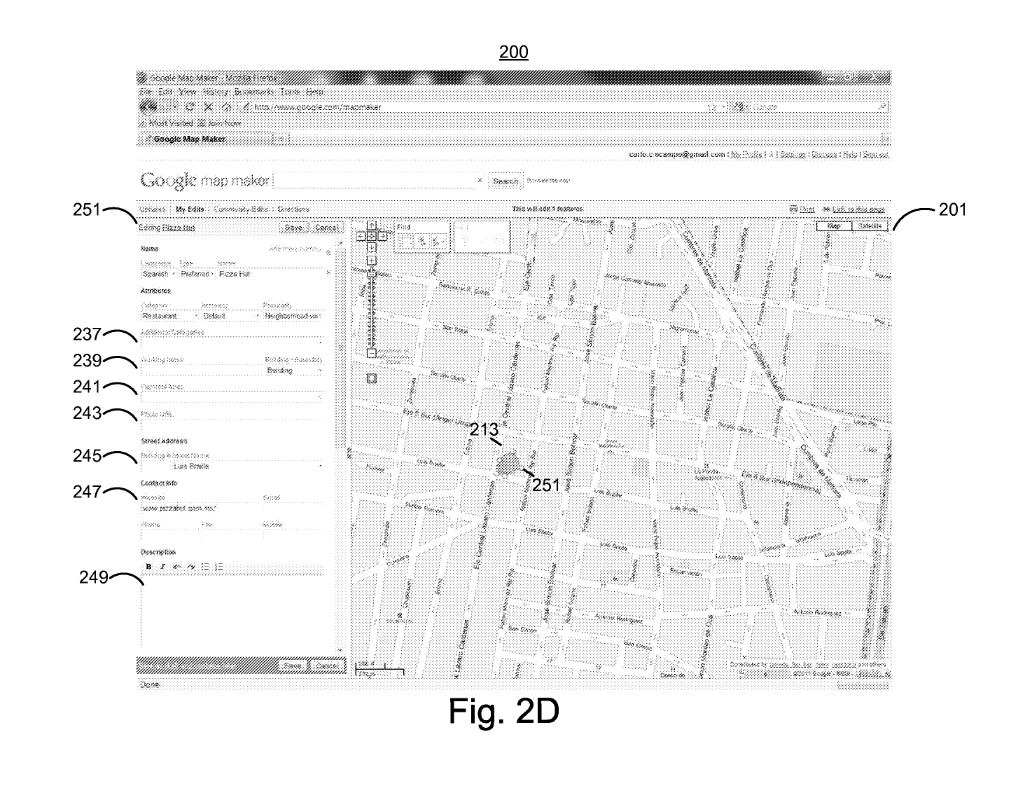

Referring now to FIGS. 2A-2D, various embodiments of a user interface 200 to submit edits of digital maps to the geographic information server 100 are shown. In the following description, the edits are submitted by a curator using user interface 200. However, note that non-contributing users may also use the user interface 200 to provide edits to the digital maps for the first time. FIG. 2A illustrates a user interface 200 comprising a map 201 of an area of Mexico City, Mexico. The user interface 200 allows the curator to select the type of feature for editing: point features 203 or line features 205. In the example shown in FIG. 2A, point features 203 are selected for editing. The user interface 200 also provides a category menu 207 from which the curator may select different categories of point features that can be edited. In this example, the category “restaurants” has been selected. The map 201 is updated accordingly to display representations (e.g., markers) 209A-209D of various restaurants within the viewing area of the map 201 upon selection of the “restaurants” category.

In one embodiment, selection of a marker causes the display of the name associated with the point feature. Additionally, the boundary of the point feature is displayed if one has been previously defined. In this example, selecting (e.g., hovering of a mouse cursor) over marker 209A causes the display of the name 211 “Pizza Hut” and the display of rectangular boundary 213 that defines the boundary of the building in which the “Pizza Hut” restaurant is located.

A second selection (e.g., clicking) of a marker causes the display of information associated with the map feature. In one embodiment, the information is provided in an information bubble, but may be provided in other interfaces such as a new browser window. The information bubble comprises general information about the map feature such as the name of the map feature and the physical address of the feature. The information bubble also provides mechanisms such as a details user interface (UI) element and an edit UI element which respectively allow the curator to view detailed information about the map feature as well as allow the curator to perform edits on information associated with the map feature.

Referring now to FIG. 2B, selection (e.g., clicking) of marker 209A causes the display of an information bubble 215 which includes the name of the restaurant “Pizza Hut” and the physical address of the restaurant, “Independencia, Benito Juarez, Distrito Federal, Mexico.” Additionally, the information bubble 215 comprises a details UI element 217 that when selected causes the display of detailed information about the “Pizza Hut” restaurant. The information bubble 315 also comprises an edit UI element 219 that when selected selection allows the curator to edit information about the restaurant. Note that the details UI element 217 and edit UI element 219 may be located in other locations in alternative embodiments.

The selection of the details UI element causes the user interface 200 to display detailed information of the map feature. In one embodiment, the detailed information associated with the map feature is dependent on the map feature type and the category associated with the map feature. For example, a point feature categorized as a “restaurant” may comprise attributes describing the hours of operation or accepted forms of payment. In contrast, a line feature categorized as a “road” may comprise attributes describing the number of lanes in the road, the speed limit, whether the road has a bicycle path, etc. Generally, the detailed information includes various information fields that describe the map feature. Not all information fields may include a corresponding value. This allows curators to view which information is yet to be provided for particular information fields for the map feature.

Referring now to FIG. 2C, information pane 221 illustrates detailed information of the “Pizza Hut” restaurant. The information pane 221 includes the following portions:
a general information portion 223 corresponding to the information included in the information bubble associated with the map feature;
a name portion 225 for the name associated with the map feature;
an attributes portion 227 for various attributes associated with the map feature (e.g., working hours, payment types, photo of the business);
a street address portion 229 for the street address (e.g., building number and street name) associated the map feature;
a contact information portion 231 for contact information (e.g., email address, phone number, fax, website, mobile number) associated with the map feature;
a description portion 233 for a general description of the map feature; and
a location information portion 235 for detailed location information (e.g., sub-locality, locality, city, district/country, state, and post code) of the map feature.

As shown in FIG. 2C, some of the information fields for the restaurant have not been completed. This indicates to curators that the map feature can be further edited by adding additional information to complete the missing information fields. Curators may also revise the information that has already been provided if an inaccuracy is present.

As noted, the information bubble also provides an edit UI element whose selection allows the curator to edit information about the map feature. Responsive to the selection of the edit UI element, the detailed information associated with the map feature becomes available for editing. For example, selection of the edit UI element 219 in FIG. 2B causes the display of an edit pane 251 as shown in FIG. 2D. Here, the information fields become available for editing. The curator is allowed to edit information which has already been provided for the map feature as well as add new information for the map feature.

For example, if the curator does not believe that the current category “Restaurant” adequately describes the map feature, the curator may add an additional category 237. The additional categories may be predefined by the geographic information server 100 or may be user contributed categories provided by the curator. The curator may also add the working hours 239 associated with the restaurant, accepted payment types 241, a photo uniform resource locator (URL) 243 for an image associated with the feature, a building number 245, or additional contact information 247 such as an email address, phone number, fax, or mobile number. Additionally, the curator may add a description 249 that describes the restaurant.

In one embodiment, the curator may also move the position of a marker that represents the map feature to a new location if the current position of the map feature is incorrect. Accordingly, an updated set of coordinates is associated with the map feature. The curator may also revise the boundary associated with the map feature. For example, in FIG. 2A, the boundary 213 of the map feature 209A is rectangular in shape. The curator may determine that the shape incorrectly describes the boundary of the restaurant associated with map feature 209A. Accordingly, the shape of the boundary 213 may be modified by the curator as shown in FIG. 2D. In this example, bubble 251 illustrates a vertex of the boundary. The curator may adjust each vertex until he or she is satisfied that the correct boundary of the map feature 209A is represented. If a map feature lacks a boundary, the curator may also define the boundary using user interface 200.

Once the curator has completed editing the map feature, the curator may submit the edits to the geographic information server 100. The activity module 105 receives the edits and indexes the edits in the activity database 113. The edits are indexed according to the time at which the edits were submitted, the author (curator) associated with the edits, the geographic region of the map feature associated with the edits, and the type of map feature.

In one embodiment, upon submission the edits are considered “pending” until further review. That is, the map feature is not associated with the edits until the edits to the feature have been approved. The approval or rejection of the edits may be determined by a system administrator of the geographic information server 100 or by one or more other curators of the digital maps 100. Alternatively, the edits may be automatically approved upon submission, thereby bypassing a formal review of the edits.

Referring back to FIG. 1, the activity distribution module 107 provides activities associated with the digital maps to users of the server 100. Specifically, the activity distribution module 107 informs other users of the edits that have been performed on the digital maps. By providing the edits to users from around the world, the users are inspired to further contribute to the editing of the maps thereby improving the accuracy of the information associated with the map features as well as expanding the breadth of the map features.

In one embodiment, the activity distribution module 107 fetches (retrieves) the latest edits from the activity database 113. The activity distribution module 107 retrieves edits that occurred within some threshold period of time. For example, the activity distribution module 107 retrieves all edits made in the last 5 minutes, the last day, or the last week. The frequency in which the activity distribution module 107 retrieves the edits from the activity database 113 as well as the number of edits retrieved may be set so that repetition of edits displayed at clients 117 is avoided.

In one embodiment, the edits are distributed to users upon explicit request. The request is received by the graph information server 100 responsive to a user selecting a control to view community edits. Alternatively, users may load a website on their browser 119 that provides community edits. In other embodiments, a user may initiate an application on client 117 that sends a request to the geographic information server 100 for the latest edits to the digital maps.

The activity distribution module 107 distributes the formatted edits in a pulse stream. In one embodiment, a pulse stream comprises a plurality of edits that have been selected according to a set of filtering parameters. The pulse stream is then formatted by the activity distribution module 107 to be presented in a visually appealing manner. Generally, the edits included in the pulse stream are temporally ordered by the activity distribution module 107 based on time of submission (i.e., no filtering parameter). Alternatively, the edits in a pulse stream may be ordered by the activity distribution module 107 according to filtering parameters (settings) set for each curator who is provided the pulse stream. These filtering parameters may filter edits in a stream based on author, region, or country. For example, a consumer of the edits may only want to view edits associated with the geographic region of “China” or “Northern California” or edits made by author “John Doe.”

If a filtering parameter based on author is set, situations may arise where the author specified in the parameter may have only provided a limited number of edits. To prevent a repetitive playback of the edits made by the author, the activity distribution module 107 may retrieve additional edits for inclusion in the pulse stream. These edits may include edits made by friends of the author, other curators within the same geographic region of the author, or revert to providing edits from all over the world.

Additionally, the filtering parameters may filter out all edits except for edits associated with specific types of map features or categories of map features. By allowing each curator to set filtering parameters, each curator may customize the edits that are provided by the geographic information server 100.

In one embodiment, each edit in a pulse stream is displayed for a threshold amount of time before the next edit in the stream is automatically displayed. Thus, the edits are displayed in a slideshow fashion, one after the other. In one embodiment, the length of time that an edit is displayed is based on the type of map feature being edited. For example, an edit associated with the creation of a geometry feature is displayed for a longer period of time compared to an edit associated with the creation of a point feature. Alternatively, the length of time that each edit is displayed in the stream is based on the number of edits included in the pulse stream. The activity distribution module 107 may calculate the amount of time needed to iterate through all the edits in the stream until the next batch of edits is retrieved from the activity database 113. Based on the total time needed to the display the edits and the number of edits in the stream, the activity distribution module 107 determines the display time for each edit.

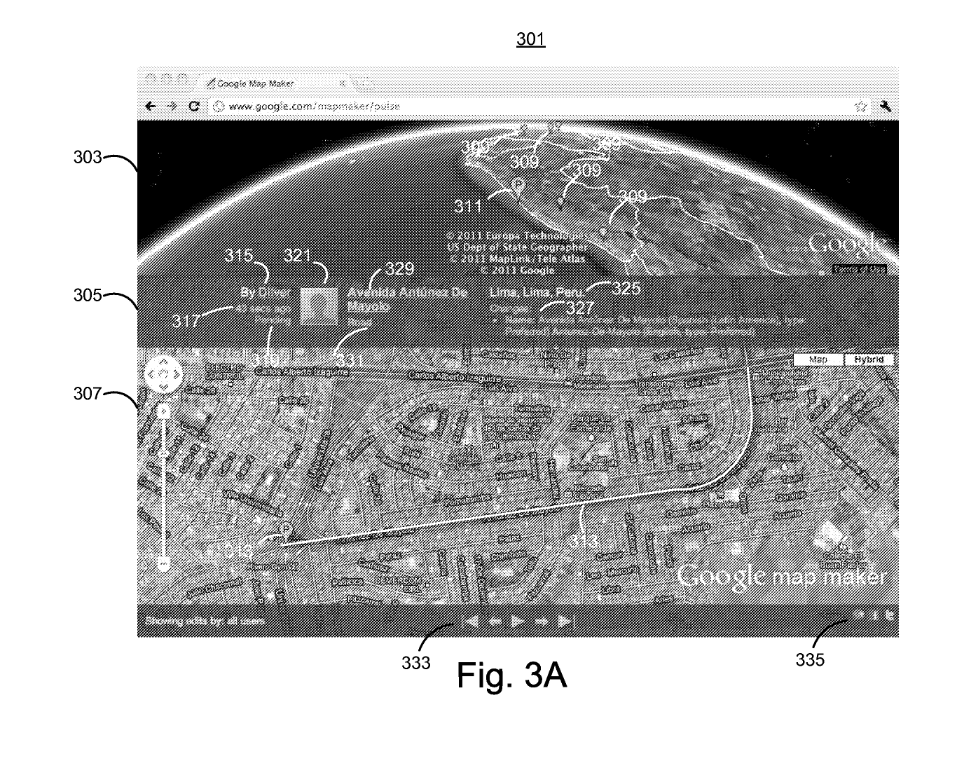

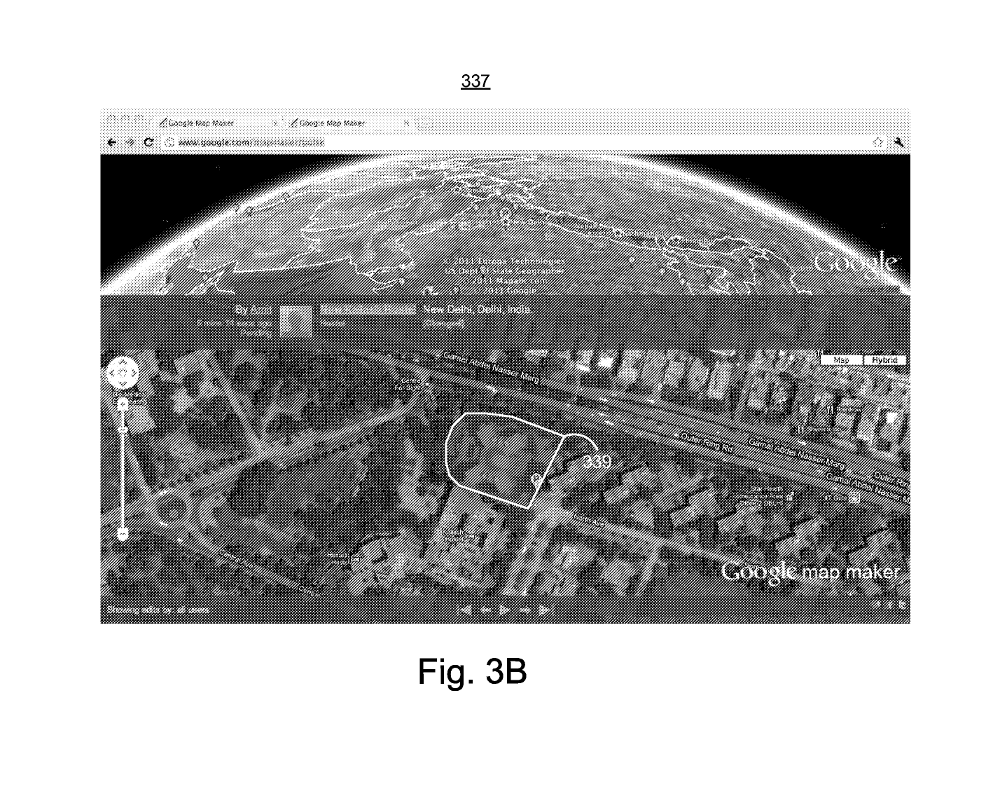

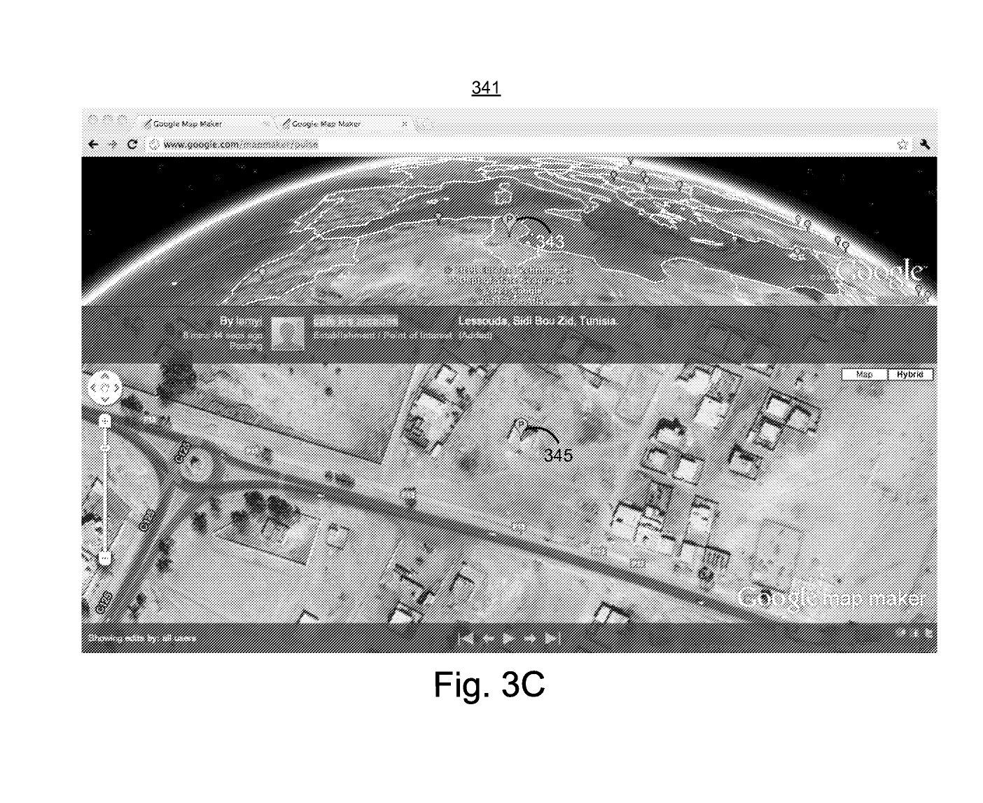

Referring to FIG. 3A, an example of a formatted edit 301 of a pulse stream is shown. In one embodiment, an edit comprises three edit portions: a global view, a snippet, and a local view, each of which will be described with respect to FIG. 3A for exemplary purposes. The global view 303 illustrates a three dimensional view of the Earth. Particularly, the top quarter of the Earth is shown that illustrates the horizon and the space beyond to make the global view 303 aesthetically pleasing.

In one embodiment, in the global view 303 the Earth is centered on the location associated with the edit. As shown in FIG. 3A, the Earth is centered on the location associated with edit 301 which is represented by marker 311. The global view 303 also illustrates locations of other recent edits that are associated with the same geographical region as the edit of interest 301. In this example, edit 301 and the edits corresponding to markers 309 are associated with the country of Peru. In one embodiment, the marker 311 associated with edit 301 is displayed more prominently compared to the markers 309 to indicate or highlight that it is the edit of interest.

The local view 307 illustrates a zoomed in map and/or satellite view of the area comprising the map feature which has been edited. The local view 307 displays a marker 313 indicating the location of the map feature which has been edited as well as a visual representation associated with the edited map feature. In this example, edit 301 corresponds to a revision of a name of a road 313. Here, the road is highlighted in the local view 311.

The snippet 305 provides textual information associated with the edit. Particularly, the snippet 305 provides information associated with the curator that submitted the edit. For example, the snippet 305 displays the user name 315 of the curator who submitted the edit, when the edit was submitted 317 (e.g., timestamp or the elapsed time since the submission), an image 321 associated with the curator, and the status 319 of the edit. The status 319 of the edit may be either approved, denied, or pending as previously described above.

In one embodiment, the snippet 305 also describes the name of the feature being edited as well as the category of feature associated with the edit. In this example, the name 329 of the feature is “Avenida Antunez De Mayolo” and the category 331 is “road.” The snippet 305 also includes the geographic region associated with the edit. In this example, the geographic region 325 “Lima, Lima, Peru” is associated with edit 301. Lastly, the snippet 305 comprises the changes 327 made to the map feature that describe the revisions that the curator made to the feature. In this example, the curator changed the name of the road from “Antunez De Mayolo” to “Avenida Antunez De Mayolo.”

Note that the placement of the portions described above may be reordered in different configurations than those illustrated in FIG. 3A. For example, the global view may be displayed in between the local view 307 and snippet 305. Also, the size of each portion may be editable to provide a larger or smaller portion.

In one embodiment, the edit 301 comprises controls 333 used to control the display the pulse stream of edits. The controls 333 include a play control to play the pulse stream of edits, a pause control to pause the playback of the pulse stream of edits, and forward and backward controls to manually traverse through the edits.

In one embodiment, edits may be shared with others to further inspire other people to contribute edits to the digital maps provided by the geographical information server 100. Sharing controls 335 may be provided in an edit. Selection of a sharing control causes the geographic information server 100 to communicate a message to users through one or more social networks 121. The message may include a URL to a website that displays a pulse stream of edits. Alternatively, sharing controls 331 allow a curator to share his or her edits to individuals who have a social relationship with the curator via a social network 121. The social network 121 may provide a application programming interface (API) that allows the curator to set a setting which causes particular individuals in the social network 121 with a social relationship (e.g., friend or family) to receive edits made by the curator. In one embodiment, the curator may setup automatic sharing of his or her exits at defined time intervals such as every X days/hours or after particular activities have occurred such as the submission of an edit adding a new point feature to a digital map.

After the edit 301 has been displayed for a length of time, a second edit 337 in the pulse stream is automatically displayed as shown in FIG. 3B. Similar to edit 301, the second edit 337 comprises a global view, a snippet, and a local view as described with respect to FIG. 3A. The description of these portions of the edit is similar to the description for FIG. 3A and is omitted for FIG. 3B for ease of description.

In one embodiment, an edit is displayed in such as a manner as to simulate its creation by the curator. In the example illustrated in FIG. 3B, a geometry feature is changed for the feature named “New Kallash Hostel.” Specifically, a curator has revised the boundary 339 of the “New Kallash Hostel.” The edit 337 is presented such that an animation feature is displayed illustrating the boundary as if the curator was drawing it at that time is it being shown, thus simulating to the viewer how the edit was made. In one embodiment, the animation illustrating the drawing of the path is normalized to be aesthetically pleasing. That is, the path is drawn in a manner that minimizes the amount of drawing strokes to complete the polygon that represents the boundary, eliminating any errors or retraces made by the curator. Alternatively, the animation may illustrate the actual path drawn by the curator associated with the edit.

After edit 337 has been displayed for a length of time, a third edit 341 in the pulse stream is automatically displayed as shown in FIG. 3C. Similar to edits 301 and 337, the third edit 341 comprises a global view, a snippet, and a local view as described above. The description of these portions of the edit is similar to the description for FIG. 3A and is omitted for FIG. 3C for ease of description. In the example shown in FIG. 3C, a curator added a new point feature represented by markers 343 and 345 respectively shown in the global view and local view of the edit 341. The new point feature is for an establishment “Café les Arcades” in Lessouda, Sidi Bou Zid, Tunisia.

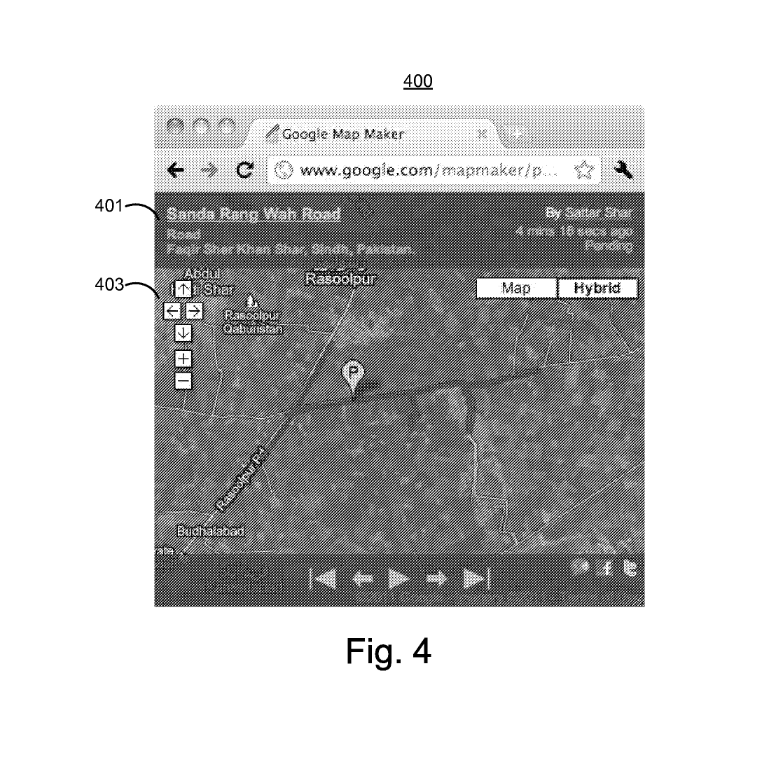

Referring now to FIG. 4, an alternative user interface of an edit 400 for a pulse stream is shown. The edit 400 comprises a snippet 401 and a local view 403, which include similar information as the snippet and local view described with respect to FIGS. 3, but edit 400 does not include the global view. The smaller user interface of edit 400 can be embedded in other websites, blogs, or social networks 121.

The edits of a pulse stream are provided to users in a continuous fashion. The geographic information server 100 may continually fetch new edits to update a pulse stream as described above to further inspire curators of the activities that have been performed by others of the digital map community.

In an alternative embodiment, a pulse stream of edits may be provided to a user via a dedicated application (e.g., map editor, screen saver, etc.) rather than through the browser 119. The application may communicate with the geographic information server 100 when a connection to the server 100 is available to receive edits for display to the user. In one embodiment, a continuous connection to the server 100 is not needed to provide a pulse stream of edits to a user. Edits may be pre-installed into a client 117 which allows the client 117 to display a pulse stream of edits when a connection to the geographic information server 100 is unavailable. When a connection to the server 100 becomes available, the geographic information server 100 may refresh the edits stored on the client 117.

### Scalability

Because a large number of users (e.g., millions) may be viewing pulse streams at one time, the geographic information server 100 determines how to improve the distribution of pulse streams to prevent server overload. Generally, the geographic information server 100 comprises a capacity C for providing pulse streams and an interval R in which the geographic information server 100 refreshes a pulse stream with new edits.

In one embodiment, when the available capacity C drops below a threshold fraction F (where F is less than 1) of the capacity C, the geographic information server 100 increases the interval R by a factor of M (where M is greater than 1). By increasing the interval in which the pulse stream is refreshed, the load on the geographic information server 100 is reduced by a factor of 1/M. To further reduce server overload, the geographic information server 100 may increase the length of time in which each individual edit of a pulse are shown or may allow repetition of edits to be shown on clients 117.

In one embodiment, to improve the distribution of pulse streams the geographic information server 100 caches batches of edits for display in particular languages. This allows the geographic information server 100 to retrieve edits from these batches when providing pulse streams to users who prefer that the edits in the streams be formatted for a particular language. Thus, the set of edits from which the geographic information server 100 retrieves edits may be minimized thereby improving the speed in which the edits are retrieved. Alternatively, batches of edits may be cached in JavaScript so that the geographic information server 100 is only contacted for new edits after an interval of time has elapsed.

### Process for Providing a Pulse Stream

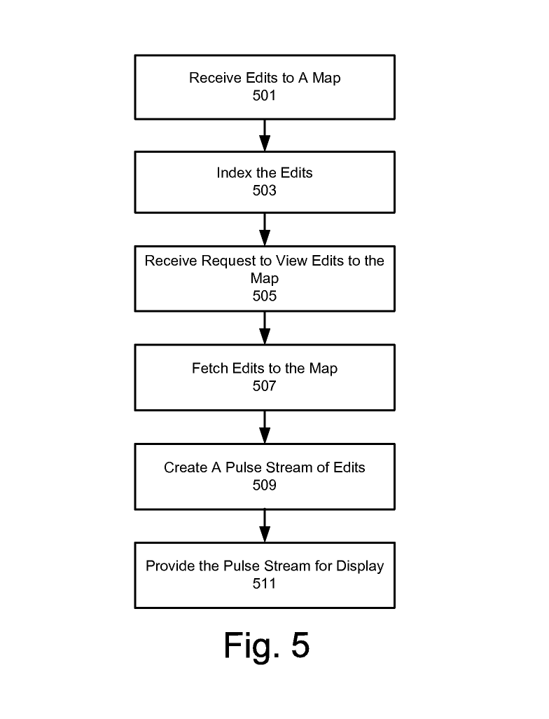

Referring now to FIG. 5, there is shown one embodiment of a method performed by the geographic information server 100 for providing a pulse stream of edits. Note that in alternative embodiments, other steps may be displayed than those shown in FIG. 5 to distribute a pulse stream of edits.

In one embodiment, the geographic information server 100 receives 501 edits to a digital map from a plurality of curators or from non-contributing users who are contributing edits for the first time. The edits may include any addition or revision of map features such as point features (e.g., restaurants, points of interest, landmarks), geometry features such as boundaries of entities such as buildings, and line features such as roads or railways. The geographic information server 100 indexes 503 the received edits. In one embodiment, the geographic information server 100 indexes the edits based on time in which the edit was submitted, the author of the edit, the geographic region associated with the map feature that was edited, and the type of map feature associated with the edit.

The geographic information server 100 receives 505 a request to view edits to the map. The request may be an explicit request provided by a user of client 117 or may be an implicit request such as loading a website that provides pulse streams in the browser 119 of the client 117. The geographic information server 100 fetches 507 the latest edits made to the map. For example, the geographic information server 100 may fetch edits that occurred within the last 5 minutes, the last day, the last week, etc. The geographic information server 100 creates 509 a pulse stream of the fetched edits. The pulse stream includes the fetched edits which have been formatted by the geographic information server 100 to be visually appealing. The geographic information server 100 provides 511 the pulse stream including the formatted edits to client 117 for display.

Reference in the specification to “one embodiment” or to “an embodiment” means that a particular feature, structure, or characteristic is included in at least one embodiment of the disclosure. The appearances of the phrase “in one embodiment” or “a preferred embodiment” in various places in the specification are not necessarily referring to the same embodiment.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects disclosed herein include process steps and instructions described herein in the form of a method. It should be noted that the process steps and instructions described herein can be embodied in software, firmware or hardware, and when embodied in software, can be downloaded to reside on and be operated from different platforms used by a variety of operating systems.

The embodiments discussed above also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the embodiments are not described with reference to any particular programming language. It will be appreciated that a variety of programming languages may be used to implement the teachings described herein, and any references below to specific languages are provided for disclosure of enablement and best mode.

While the disclosure has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the invention.

We claim:

1. A computer-implemented method for distributing a pulse stream of edits made to a digital map, the method comprising:
retrieving indicia of edits to the digital map made by a plurality of curators, each edit associated with a feature of the digital map;
creating a graphical representation for each of a plurality of the indicated edits;
creating a pulse stream comprising the plurality of edits made to the digital map, the pulse stream including the graphical representation for each of the plurality of indicated edits; and
providing the pulse stream to a user of the digital map.

2. The computer-implemented method of claim 1, wherein a feature represents a stationary real world object that is represented on the digital map by at least a name and a geographic location.

3. The computer-implemented method of claim 1, wherein an edit describes an addition of the feature to the digital map.

4. The computer-implemented method of claim 1, wherein an edit describes a revision of existing information associated with the feature of the digital map.

5. The computer-implemented method of claim 1, wherein an edit describes an addition of information associated with the feature of the digital map.

6. The computer-implemented method of claim 1, wherein retrieving indicia of edits comprises:
identifying a plurality of edits that were submitted during a time period; and
retrieving the identified plurality of edits for formatting.

7. The computer-implemented method of claim 1, wherein retrieving the indicia of edits comprises:
identifying filtering parameters of edits associated with the user of the digital map;
identifying a plurality of edits according to the filtering parameters; and
retrieving the identified plurality of edits for formatting.

8. The computer-implemented method of claim 7, wherein the filtering parameters include a parameter describing a user name of another curator.

9. The computer-implemented method of claim 7, wherein the filtering parameters include a parameter describing a geographic region of interest to the user.

10. The computer-implemented method of claim 7, wherein the filtering parameters include a parameter describing a type of feature of interest to the user.

11. The computer-implemented method of claim 1, further comprising:
retrieving additional edits to refresh the pulse stream to prevent providing the user with repetitive edits that were previously provided to the user;
formatting each of the additional edits to graphically and textually indicate the edit associated with the feature corresponding to the edit; and
updating the pulse stream with the formatted edits.

12. The computer-implemented method of claim 1, wherein creating a graphical representation for each of the plurality of the indicated edits comprises:
for each of the plurality of the indicated edits:
creating a first edit portion that highlights a plurality of locations on a globe, each location corresponding to a geographical region associated with the edit;
creating a second edit portion that comprises a map of an area comprising a location of the feature corresponding to the edit;
creating a third edit portion that textually describes the edit; and
creating the formatted edit using the first edit portion, the second edit portion, and the third edit portion.

13. The computer-implemented method of claim 1, wherein creating the pulse stream comprises:
ordering the graphical representations of the plurality of indicated edits based on time of submission of each edit.

14. The computer-implemented method of claim 1, wherein each of the formatted edits in the pulse stream are displayed to the curator for a duration of time.

15. The computer-implemented method of claim 1, wherein the duration of time is variable based on a type of feature associated with each edit.

16. The computer-implemented method of claim 1, wherein the duration of time is based on a total number of edits included in the pulse stream.

17. A computer program product comprising a non-transitory computer-readable storage medium containing computer program code for distributing a pulse stream of edits made to a digital map, the code for:
retrieving indicia of edits to the digital map made by a plurality of curators, each edit associated with a feature of the digital map;
creating a graphical representation for each of a plurality of the indicated edits;
creating a pulse stream comprising the plurality of edits made to the digital map, the pulse stream including the graphical representation for each of the plurality of indicated edits; and
providing the pulse stream to a user of the digital map.

18. A system for distributing a pulse stream of edits made to a digital map, the system comprising:
at least one server computer comprising a computer processor, the computer processor configured to execute instructions stored on a computer-readable storage medium, the instructions when executed by the computer processor cause the processor to:
retrieve indicia of edits to the digital map made by a plurality of curators, each edit associated with a feature of the digital map;
create a graphical representation for each of a plurality of the indicated edits;
create a pulse stream comprising the plurality of edits made to the digital map, the pulse stream including the graphical representation for each of the plurality of indicated edits; and
provide the pulse stream to a user of the digital map.
